(19) United States
(12) Patent Application Publication
(10) Pub. No.: US 2025/0262110 A1
(43) Pub. Date: Aug. 21, 2025

(54) DENTAL INSTRUMENT HOLDER AND EXPANSION PLATFORM

(71) Applicant: A-DEC, INC., Newberg, OR (US)

(72) Inventors: Joshua Paul Federspiel, Newberg, OR (US); Michael William Whalen, Newberg, OR (US)

(21) Appl. No.: 19/055,364

(22) Filed: Feb. 17, 2025

Related U.S. Application Data
(60) Provisional application No. 63/555,352, filed on Feb. 19, 2024.

(51) Int. Cl. A61G 15/16

(52) U.S. Cl. CPC A61G 15/16

(57) ABSTRACT

An attachment apparatus is provided allowing a tool of a non-standard size to be incorporated into an existing system, such as a dental system, with standard-sized tools. In one implementation, the attachment apparatus includes a holder, adapter body and clamp to secure a scanner or other tool to an arm of the system. The apparatus may cover one tool slot of the arm while other tool slots remain available for standard-sized tools. In another implementation, the attachment apparatus can be attached to a console that may hold standard-sized tools. The attachment apparatus includes a channel for a cord of an additional tool to securely hold the cord and route it to electronic components within the console. The cord may carry power to and data to/from the tool.

### CLAIM OF PRIORITY

This application claims the benefit of U.S. provisional patent application No. 63/555,352, filed Feb. 19, 2024, titled “Dental Instrument Holder And Expansion Platform,” and incorporated herein by reference.

### TECHNICAL FIELD

Embodiments herein relate to methods and apparatus for expanding the capability of an existing system to hold a tool and to route a cord of a tool into the system. Example embodiments include a dental delivery system.

### BACKGROUND

Dental delivery systems are used to hold various tools for use by a dentist. The tools traditionally include those that provide pressurized air, suction and water and mechanical instruments that operate based on electric power or using air turbines, such as cutting burs and polishing discs. These hand held tools are typically held in an array of standardized slots in the system so that they are easily accessible to the dentist. Hoses or electric cords of the tools extend to associated equipment which may be proximate to the system. However, the dental delivery systems typically do not have the ability to accommodate new, non-standard types of tools and it is impractical to replace the systems due to their high cost and widespread use.

### BRIEF DESCRIPTION OF THE DRAWINGS

Embodiments will be readily understood by the following detailed description in conjunction with the accompanying drawings and the appended claims. Embodiments are illustrated by way of example and not by way of limitation in the figures of the accompanying drawings.

FIG. 1 depicts an example dental delivery system 100, in accordance with various embodiments.

FIG. 2A depicts an example implementation of a scanning station 200 separate from the dental delivery system 100 of FIG. 1, in accordance with various

FIG. 2B depicts an example implementation of the scanner 210 of FIG. 2A, in accordance with various embodiments.

FIG. 3A depicts an example close-up view of the elongated arm 110 of FIGS. 1 and 3A, in accordance with various embodiments.

FIG. 3B depicts an example profile view of the elongated arm 110 of FIG. 3A in the y-z plane along the nub 311, in accordance with various embodiments.

FIG. 4 depicts an exterior side view of an example implementation of an adapter 405 and a holder 410 for use with the elongated arm 110 of FIGS. 1 and 3A, in accordance with various embodiments.

FIG. 5 depicts a cross-sectional view of the adapter 405 and holder 410 of FIG. 4, in accordance with various embodiments.

FIG. 6A depicts an example side view of the clamp 420 of FIG. 4 in a y-z plane, in accordance with various embodiments.

FIG. 6B depicts an example front view of the clamp 420 looking in the direction of the arrow 610 of FIG. 6A, in an x-z plane, in accordance with various embodiments.

FIG. 6C depicts an example structure of the adapter body 415 of FIG. 4, in accordance with various embodiments.

FIG. 7 depicts an example cross-sectional view of the adapter body 415 cut in a y-z plane along the tension screw 430, in accordance with various embodiments.

FIG. 8 depicts an example cross-sectional view of the adapter body 415 showing threads of the tension screw 430, in accordance with various embodiments.

FIG. 9 depicts an example cross-sectional view of the adapter body 415 showing forces on the tension screw 430, in accordance with various embodiments.

FIG. 10 depicts an example cutaway view of the adapter body 415 showing its attachment to the clamp 420 and the holder 410, in accordance with various embodiments.

FIG. 11 depicts an example cross-sectional of a comparative adapter body 1115 with a vertical tension screw 1130, in accordance with various

FIG. 12 depicts an example view of an attachment apparatus 1200 for a tool console 1250, in accordance with various embodiments.

FIG. 13 depicts an example view of an interior of the tool console 1250 of FIG, 12, with the left side attachment apparatus 1200 of FIG. 12 and a right side attachment apparatus 1280, in accordance with various embodiments.

FIG. 14 depicts a view of an example implementation of the attachment apparatus 1200 of FIG. 12 and associated structures, in accordance with various embodiments.

FIG. 15 depicts an exploded view of the attachment apparatus 1200 and associated structures of FIG. 14, in accordance with various embodiments.

FIG. 16 depicts an exploded cross-sectional view of the attachment apparatus 1200 of FIG. 14 in the y-z plane, where a screw 1510 and the bracket 1310 are detached from the attachment apparatus 1200, in accordance with various embodiments.

FIG. 17 depicts a cross-sectional view of the attachment apparatus 1200 of FIG. 16, where the screw 1510 and the bracket 1310 are attached to the attachment apparatus 1200 to provide a compression section 1200cs of a channel 1200c, in accordance with various embodiments.

FIG. 18 depicts a cross-sectional view of the attachment apparatus 1200 in an x-z plane, showing a contact radius of a first channel surface 1201c and a second channel surface 1202c along the length L of the compression section 1200cs of FIG. 17, in accordance with various embodiments.

FIG. 19 depicts a view of the attachment apparatus 1200 with the cap 1202 detached from the body 1201, in accordance with various embodiments.

FIG. 20 depicts a view of the attachment apparatus 1200 with the cap 1202 attached to the body 1201, in accordance with various embodiments.

FIG. 21 depicts a view of the cap 1202 of the attachment apparatus 1200, showing the aperture 1202h which is sized to pass through a cord connector 1221, in accordance with various embodiments.

FIG. 22 depicts a view of the cap 1202 attached to the body 1201 of the attachment apparatus 1200, showing a gate 1202g of the cap mating to the receptacle 1201r of the body 1201, a groove 1201g of the receptacle 1201r, and a groove 1209 of the gate, without a cord present, in accordance with various

FIG. 23 depicts an underside of the body 1201 of the attachment apparatus 1200, showing the cord boot 1222 mated via a flange 1222f to the groove of the receptacle 1201r, in accordance with various embodiments.

FIG. 24 depicts the cap 1202 mated to the body 1201 of FIG. 23, in accordance with various embodiments.

FIG. 25 depicts a view of an attachment apparatus 2500 which provides another example implementation of the attachment apparatus 1200 of FIG. 12, in accordance with various embodiments.

FIG. 26 depicts an upward view of the body 2501, cap 2502 and bushing 2505 of FIG. 25, in accordance with various embodiments.

FIG. 27 depicts a downward view of the body 2501, cap 2502 and bushing 2505 of FIG. 25, in accordance with various embodiments.

### DETAILED DESCRIPTION OF DISCLOSED EMBODIMENTS

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical contact with each other. “Coupled” may mean that two or more elements are in direct physical contact. However, “coupled” may also mean that two or more elements are not in direct contact with each other, but yet still cooperate or interact with each other.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A) B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous, and are generally intended as “open” terms (e.g., the term “including” should be interpreted as “including but not limited to,” the term “having” should be interpreted as “having at least,” the term “includes” should be interpreted as “includes but is not limited to,” etc.).

With respect to the use of any plural and/or singular terms herein, those having skill in the art can translate from the plural to the singular and/or from the singular to the plural as is appropriate to the context and/or application. The various singular/plural permutations may be expressly set forth herein for sake of clarity.

As mentioned at the outset, various challenges are presented in adding new types of tools to an existing system.

One possible example involves a dental delivery system. A typical dental delivery system may include a console, also referred to as a control head, with slots sized to hold a handheld dental tool and/or arms configured with slots to hold such tools. Example systems include those available from A-dec Inc., Newberg, Oregon.

However, these slots are not suitable for holding some new types of tools such as certain scanners, curing lights, touch pads, apex locators or other instruments, whether corded or non-corded. The term “cord” as used herein can include, e.g., a cable comprising wires encased within a sheathing, tubing such as one or more tubes carrying water or air, or a sheathed system of tubing and/or one or more cables. For instance, oral 3D scanners are becoming increasingly common. One example is the Primescan® intraoral scanner available from Dentsply Sirona, Charlotte, NC. 3D scans of a patient's teeth can be used, e.g., to quickly design and build dental implants, assess teeth to provide necessary care, and create orthodontic mouthpieces. To create a 3D scan of the oral cavity, a dentist scans the upper and lower bridge of the patient's teeth with a handheld digital scanner. The dentist holds the scanner in one hand while tracing the scanner lens/tip over the upper and lower arch. Light beams exit the scanner lens and reflect off the teeth. The scanner measures the light beams and creates a 3D image of light beam measurements. The scanner can be coupled to a laptop or other computer via a cord.

However, these scanners are currently poorly integrated into the workflow of common dental hand pieces. In particular, the scanner is located on a rolling cart independent of the tool-holding system. The rolling cart has to be moved and plugged into a wall outlet for use in different operatories of a dental office, for example. Moreover, the location and use of the scanner cart places the dentist's body into awkward and uncomfortable positions.

There are numerous challenges in attaching a scanner to the existing systems. For example, an attachment apparatus should be compatible with different sizes and shapes of systems. Other goals can include ease of cleaning, ease of attachment, right/left accommodation, avoiding or minimizing interference with existing tools, affordability, ease of system and manufacture, mechanical durability, accommodating different tool cradles or other holding mechanisms, and aesthetics. Other goals can include avoiding collisions with existing swing arms, trays, under mounts, chairs, chair arms, stools, cabinets, monitors, touch pads, handpiece tubing drape, and countertops.

The solutions provided herein addresses the above and other issues. In one aspect, an attachment apparatus is provided allowing a tool of a non-standard size, e.g., larger than standard, to be incorporated into an existing system with standard-sized tools. The attachment apparatus can include a cradle that holds a scanner or other tool adjacent to the standard-sized tools so that it is easily accessible to a dentist or other user. In another aspect, the attachment apparatus can hold and route a cord of the tool to electronic components within a console or other location.

In an example implementation, the attachment apparatus is attached to an arm that includes slots for holding standard-sized tools. The attachment apparatus can include a clamp that attaches an adapter body and holder over one of the slots, leaving the remaining slots available for the standard-sized tools. The adapter body can be configured to avoid interference with nubs or other protuberances that extend from the arm to hold the standard-sized tools. For example, the adapter body can include curved edges configured to contact a front side of the arm, a cavity between the curved edges which accommodates the nubs, and a tension screw which is seated in the adapter body outside the cavity, and which may extend in a generally horizontal orientation. The clamp can include tabs attached at a first end of the clamp to the adapter body and at a second end of the clamp to the tension screw via a fastener. A clockwise rotation of the tension screw results in tightening when the tension screw is left-hand threaded.

In another example implementation, an attachment apparatus includes a holder for a non-standard sized tool and also has a capability to hold and route a cord from the tool into a console for attachment to electronic components within the console or other location. The cord can provide power to the tool as well as send/receive data.

The attachment apparatus can include a body and a cover, where the cord extends along a channel that is formed by upper and low surfaces within the body and cover, respectively. When the cover is attached to the body, the cord is compressed in a compression section of the apparatus between a first channel surface of the body and a second channel surface of the cover, to provide strain relief for the cord. The cover also includes a receptacle with an in-cut or interior groove to mate with a flange in a cord boot. When the cover is attached to the body, a gate of the cover mates with the receptacle to hold the cord boot in place. The gate includes a corresponding interior groove.

The above and other features can be understood further in view of the following discussion.

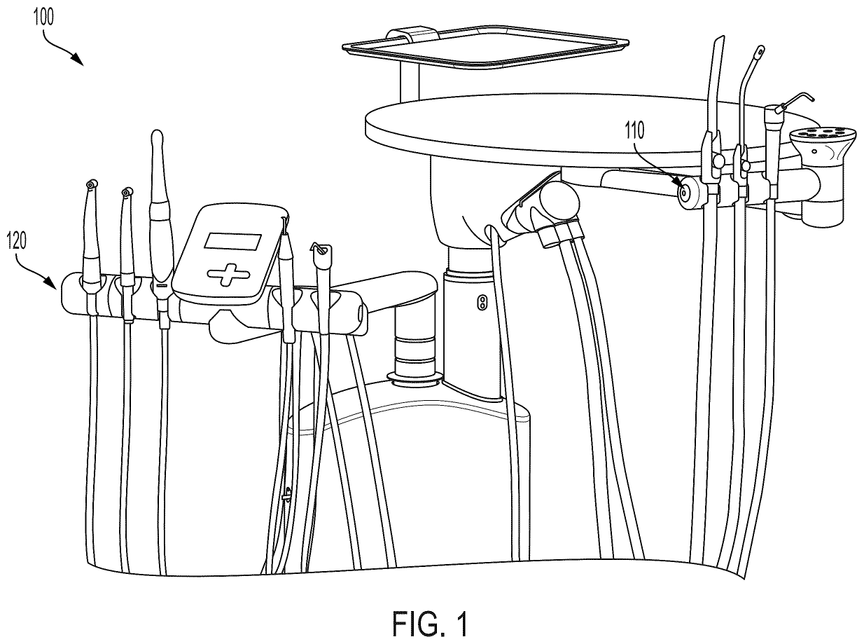

FIGS. 1-11 relate primarily to embodiments of an attachment apparatus attached to an arm which includes slots for holding standard-sized tools.

FIG. 1 depicts an example dental delivery system 100, in accordance with various embodiments. The delivery system includes a dentist's station on the left and an assistant's station on the right. The dentist's station or delivery system may include, e.g., tools such as electric or pneumatic handpieces for operating rotary instruments, such as cutting burs and polishing discs, an ultrasonic scaler, an intraoral camera, anair/water syringe or other tools. The assistant's instrumentation may include, e.g., an air/water syringe, suction instruments, such as a high-volume evacuator and saliva ejector, or other tools. The tools are held on horizontally extending instrumentation arms 110 and 120 and include cords routed to locations within the system.

The arms 110 and 120 may have diameter of 1.5 and 2 inches, respectively, such as used in dental operatories. Other diameters are possible.

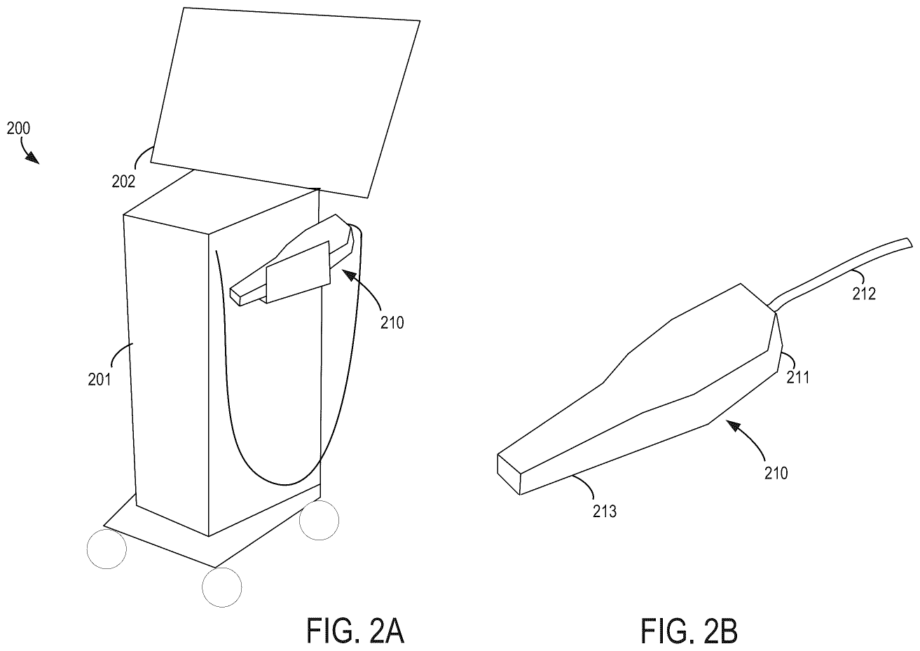

FIG. 2A depicts an example implementation of a scanning station 200 which is separate from the dental delivery system 100 of FIG. 1, in accordance with various embodiments. The scanning station includes a wheeled body 201 housing electronic components, a display screen 202 and a scanner 210.

FIG. 2B depicts an example implementation of the scanner 210 of FIG. 2A, in accordance with various embodiments. The scanner includes a tip 213, which is placed into to patient's mouth to obtain images of the mouth, a body 211 which may contain electronic components for power and data, and a cord 212 coupled to the electronic components in the wheeled body. For example, the electronic components may provide 24 V to the scanner and well as send and receive data.

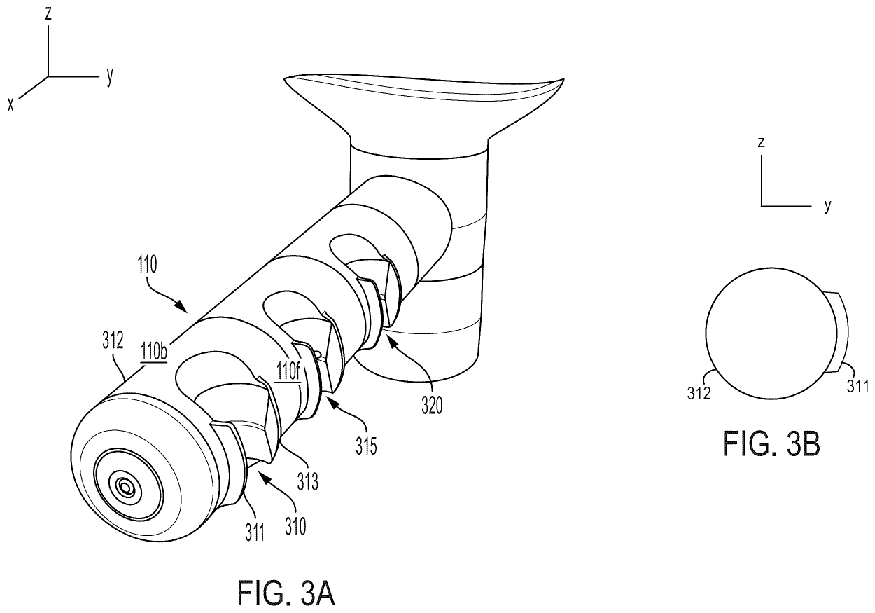

FIG. 3A depicts an example close-up view of the elongated arm 110 of FIGS. 1 and 3A, in accordance with various embodiments. The arm has a generally cylindrical portion 312 in this example, although other shapes are possible. The arm includes three slots 310, 315 and 320 for standard-sized tools such as depicted in FIG. 1. Additionally, nubs or protuberances such as nubs 311 and 313 of slot 310 extend out from the front side of the arm to help hold the tools. In other implementations, nubs are not used. In some cases, the slots are tapered to facilitate holding of the tools. The slots may also have the ability to rotate in a limited range relative to the longitudinal axis of the arm to allow optimal positioning.

The arm has a front side 110f and a back side 110b.

FIG. 3B depicts an example profile view of the elongated arm 110 of FIG. 3A in the y-z plane along the nub 311, in accordance with various embodiments. The arm includes the cylindrical portion 312 and the nub 311. As mentioned, the arm can have other cross-sectional shapes. For example, the cross-section can be generally rounded, such as elliptical. The arm can include both rounded and flat surfaces, or all flat surfaces, such as a polygon or square or other rectangular shape.

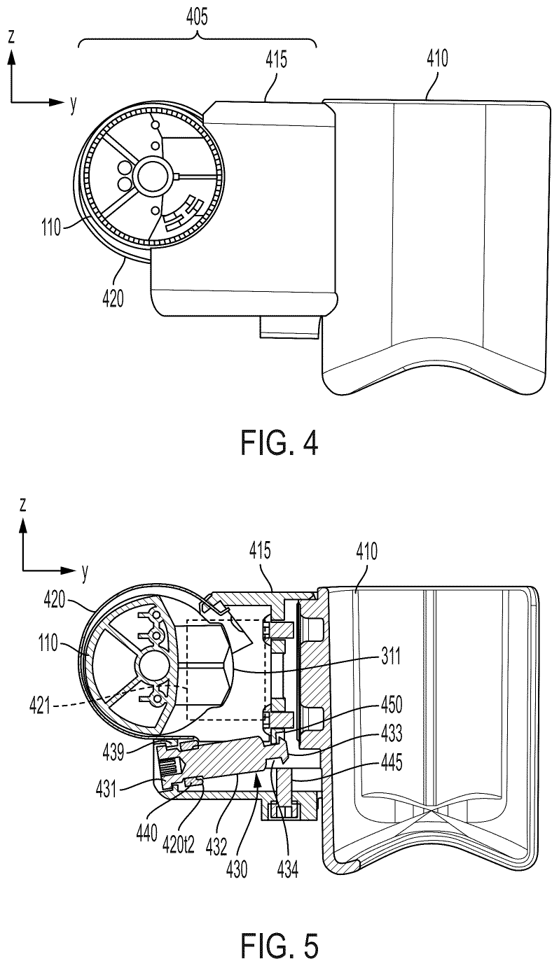

FIG. 4 depicts an exterior side view of an example implementation of an adapter 405 and a holder 410 for use with the elongated arm 110 of FIGS. 1 and 3A, in accordance with various embodiments. The holder 410 may be in the form of a cradle for holding a tool such as the scanner 210 of FIG. 2A. Other holding mechanisms are possible as well, such as a hook, pin or hanger. The holder can be fixed or moveable, such as with spring-loaded arms to hold a tool. The holder can hold the tool in a generally vertical orientation, in one approach.

The holder is attached to an adapter body 415 of an adapter 405 in this example. In another example, the holder is integral, or formed in one piece with, the adapter body. The holder and adapter body can be formed from plastic or other suitable material. The holder can be easily swapped in the field for device upgrades or changes.

The adapter 405 also includes a band clamp 420 that extends around the arm 110. In one approach, the band clamp is initially in a loose position to allow the adapter to be slid onto the arm from the free end of the arm. The band clamp should open to the extent needed to slip over the arm and any nubs or other protuberances. The clamp can be attached to a tension screw in the adapter body, where a head of the screw is externally accessible to tighten or loosen the clamp. A user may use a screwdriver to tighten or loosen the clamp. When the clamp is tightened, it clamps the surface of the arm, including the back side 110b, to hold the adapter body and holder in place. The clamp can be formed from a steel sheet, in one approach.

The arm may comprise plastic which is susceptible to marring when the clamp was tightened. Powder coating the clamp can avoid this problem. Another approach is to provide a plastic liner.

FIG. 5 depicts a cross-sectional view of the adapter 405 and holder 410 of FIG. 4, in accordance with various embodiments. A tension screw 430 is held within the adapter body 415 to adjust the tightness of the clamp 420. The term “screw” or the like is meant to include, e.g., any threaded fastener which may be referred to as a screw, bolt or other fastener.

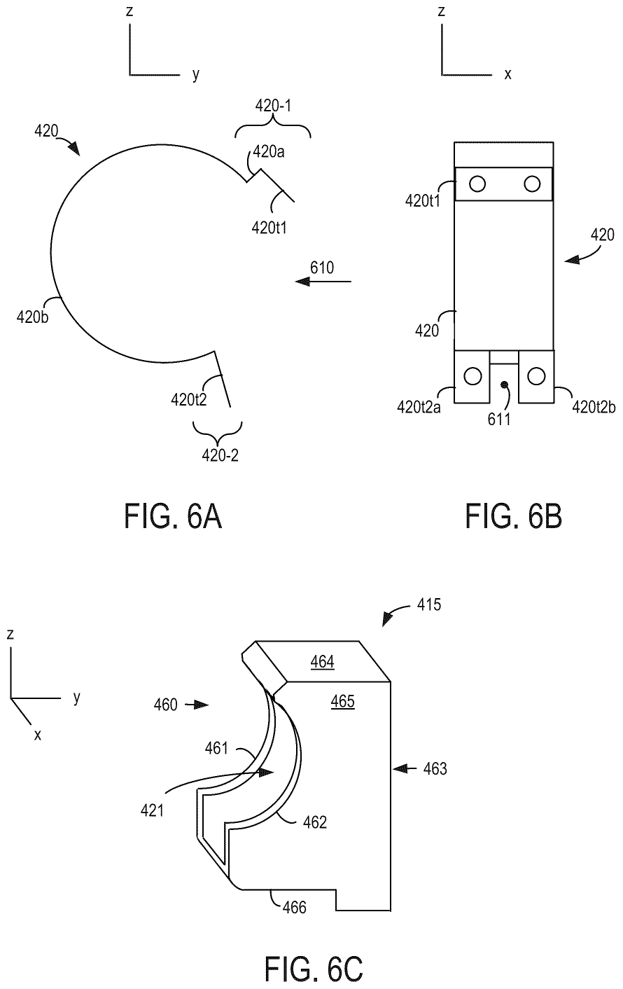

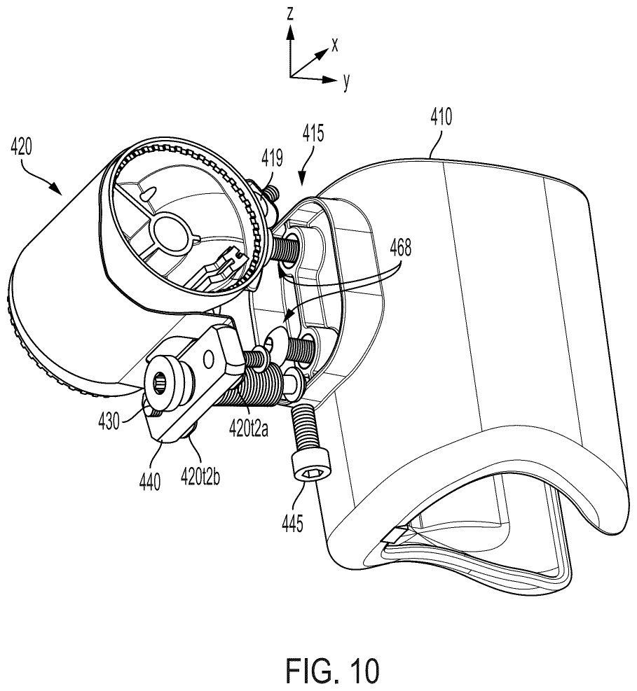

The clamp can include a first end 420-1 (see FIG. 6A and 6B) fixed to the adapter body by a screw 419 (FIG. 10), for example, and a second end 420-2 fixed to a fastener 440. The fastener can comprise, e.g., a nut or other fastener with internal threads. In particular, a first tab 420t1 of the first end of the clamp can be fixed to the adapter body by a screw, and a second tab 420t2 of the second end of the clamp can be fixed to the fastener.

The fastener is threaded onto a threaded shaft 432 of the tension screw. The tension screw 430 has a tip 433 with a circumferential groove 434 held in a first seat 450 of the adapter body to limit upward movement. A downward movement of the tip 433 can be limited by positioning a retaining screw 445 from a bottom side of the adapter body.

The tension screw 430 has a head 431 which can be slotted, Phillips, square, hex, etc. to allow the screw to be driven by a common hand tool. The head is held in a second seat 439 of the adapter body. The first and second seats of the adapter body can substantially prevent longitudinal movement of the tension screw. The first and second seats can be arcuate to allow rotational movement of the tension screw. The tension screw 430 is outside and below a cavity 421 of the adapter body which accommodates the nub 311 of the arm. The cavity can be formed between first and second curved edges 461 and 462, respectively (see FIG. 6C) of the adapter body which contact the front side 110f of the arm when the clamp is tightened.

In one approach, the screw is left-hand threaded so that a clockwise movement of the tension screw 430 results in tightening the clamp by moving the fastener forward, in the direction of the tip 433. This is advantageous as it allows the screw head to be located on the back of the adapter body, facing away from the holder. This location places dirt-catching gaps away from the patient work area and the dentist's hands.

Alternatively, the screw could be flipped from the orientation shown, where the head of the screw is accessible via a hole in the holder/cradle. However, this results in a gap where the screw head would enter the hole that could catch dirt and transfer it back to the scanner or other tool.

The tension screw may be positioned so that a longitudinal axis of the tension screw extends generally horizontally, e.g., within +/−30 degrees of a horizontal direction.

In one approach, the tension screw, the retainer screw and screws used to attach the adapter body to the holder all face away from, or are hidden from, the holder so that they are not subject to accumulating debris from the patient work area.

FIG. 6A depicts an example side view of the clamp 420 of FIG. 4 in a y-z plane, in accordance with various embodiments. The clamp includes a band 420b that terminates at a first end 420-1 with a bend 420a and a first tab 420t1, and at an opposite second end 420-2 with a second tab 420t2. The band can have a generally circular shape or a shape with otherwise corresponds to the cross-sectional shape of the arm.

FIG. 6B depicts an example front view of the clamp 420 looking in the direction of the arrow 610 of FIG. 6A, in an x-z plane, in accordance with various embodiments. The first tab 420t1 has two holes to allow the first tab to be fixed to the adapter body using screws. The second tab 420t2 has two tab portions 420t2a and 420t2b to allow the second tab to be fixed to the fastener. A space 611 between the tab portions provides room for the tension screw. In this example, the fastener can include two threaded holes aligned with respective holes in the tab portions 420t2a and 420t2b to allow screws to secure the fastener to the tab portions.

FIG. 6C depicts an example structure of the adapter body 415 of FIG. 4, in accordance with various embodiments. The adapter body includes a front side 460 facing the arm to which it is attached, an opposite back side 463, a top side 464, a bottom side 466, and opposite side walls, including side wall 465. As mentioned, the front side has first and second curved edges 461 and 462, respectively, which contact the arm when the clamp is tightened, and the cavity 421 is formed between first and second curved edges.

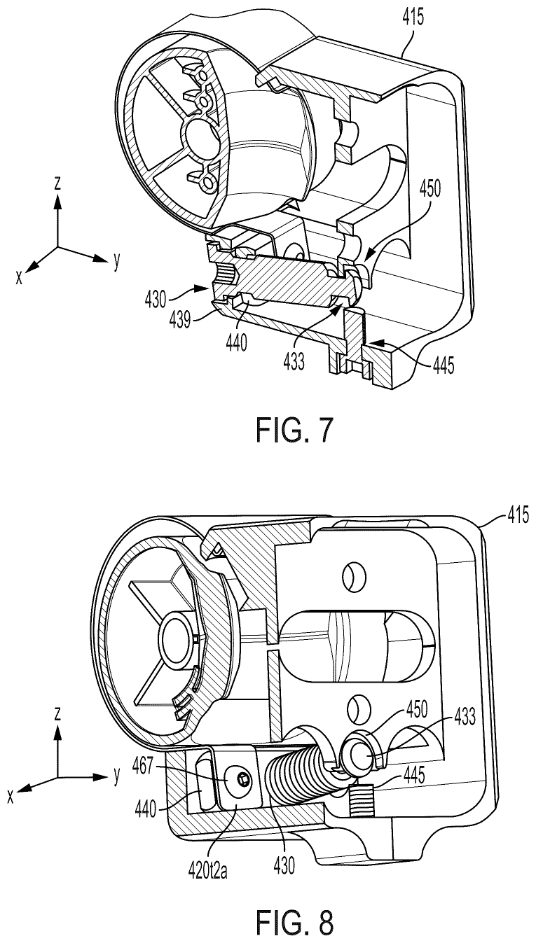

FIG. 7 depicts an example cross-sectional view of the adapter body 415 cut in a y-z plane along the tension screw 430, in accordance with various embodiments. The view provides further details of the tension screw 430, the fastener 440, the tip 433 of the tension screw, and the first seat 450 of the adapter body in which the tip rests. The seat allows the tip and tension screw to rotate without moving in a longitudinal direction of the tension screw. The head of the tension screw can be held in the second seat 439 of the adapter body, as mentioned.

FIG. 8 depicts an example cross-sectional view of the adapter body 415 showing threads of the tension screw 430, in accordance with various embodiments. The view provides further details of the retaining screw 445, the first seat 450, the tension screw 430 including its tip 433, the fastener 440 and the tab 420t2a fixed to the fastener by a rivet or screw 467, for example.

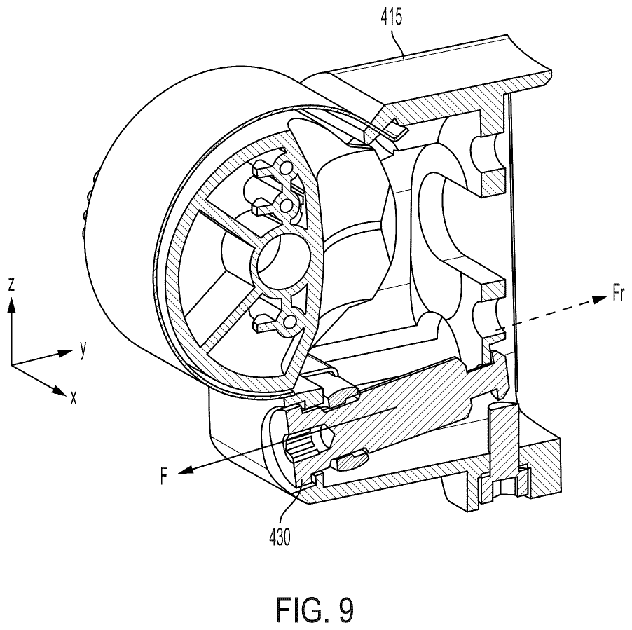

FIG. 9 depicts an example cross-sectional view of the adapter body 415 showing forces on the tension screw 430, in accordance with various embodiments. The tensioning mechanics are reversed from common pipe clamps, as the tip of the tension screw is loaded against the adapter body seat 450. In this case, there is a force F in the leftward direction and a corresponding resistive force Fr in the rightward direction.

FIG. 10 depicts an example cutaway view of the adapter body 415 showing its attachment to the clamp 420 and the holder 410, in accordance with various embodiments. As mentioned, the adapter body can be a separate component than the holder. In this case, fasteners such as screws 468 can be used to attach the adapter body to the holder. Other details includes the tension screw 430, the fastener 440, the tabs 420t2a and 420t2b, and the retaining screw 445. The fastener in this example is rectangular and includes two threaded holes to allow the two tabs 420t2a and 420t2b to be fastened.

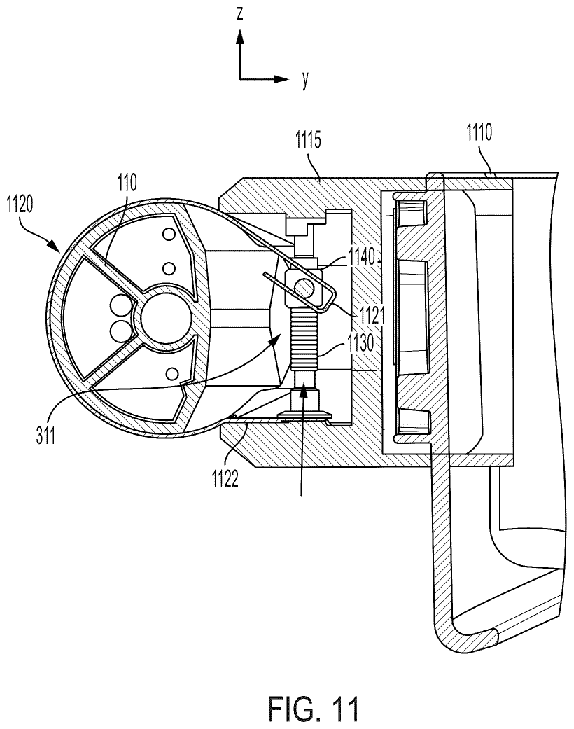

FIG. 11 depicts an example cross-sectional of a comparative adapter body 1115 with a vertical tension screw 1130, in accordance with various embodiments. In this case, a clamp band 1120 includes a first end 1121 attached to a fastener 1140, and a second end 1122 attached to the adapter body 1115. A holder 1110 is attached to the adapter body 1115. When the tension screw is turned clockwise, e.g., driven from the head at the bottom, the fastener and band move downward. This arrangement, which represents a typical pipe clamp, has a problem in that the tension screw can collide with the nub 311 of the arm 110. To avoid a collision, the size of the adapter body would have to be increased at least in the y direction. Such an increase in size would result in the tool location being moved further away from the arm and thereby exerting a greater torque which may require further upsizing of the band or other components, thereby increasing costs and consuming more space in the work area.

In contrast, as discussed previously, a solution is found by providing a cavity within the adapter body and moving the tension screw to a location outside the cavity which does not interfere with the nub on the front side of the tool-holding arm.

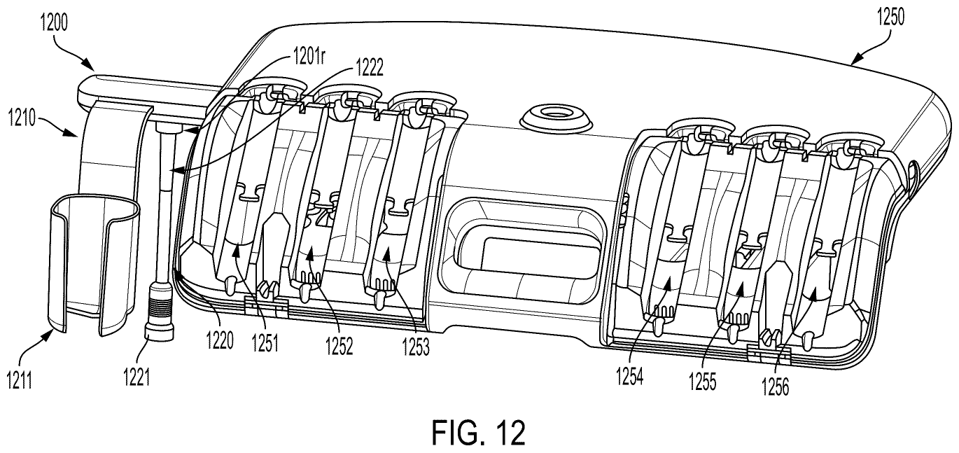

FIGS. 12-18 relate primarily to embodiments of an attachment apparatus that includes a holder for a non-standard sized tool and also has a capability to hold and route a cord from the tool into a console for attachment to electronic components within the console or other location.

FIG. 12 depicts an example view of an attachment apparatus 1200 for a tool console 1250, in accordance with various embodiments. The tool console includes a number of slots 1251-1256 for holding hold tools. Each tool typically has a cord coupled to an air, water, electrical power, suction or electronic data control source. In this example, the console is limited to holding six tools of the same standard size.

To expand the capability of the console, an attachment apparatus can be installed in the left and/or right sides of the console. In this example, an attachment apparatus 1200 is installed at the left-side of the console. The console may have opposing top and bottom sides, opposing left and right sides, and opposing front and back sides. The attachment apparatus can be used for routing a cord 1220 to the interior of the console via an opening made in the side of the console. In an example implementation, the opening is plastic or metal and can be easily cut to provide a port, or a pre-cut opening may be available. The cord can have an opposing end, not shown, attached to electronic components within the console, for example, such as a coupling box or instrument control module, or is routed out of the console through another opening in the console to another location such as a computer. The cord can carry power and/or data for a tool that is held in a holder 1211, in one approach. One possible implementation of the tool involves an oral scanner such as depicted in FIG. 2B. The data can include control signals sent to the tool and image data received from the tool. The holder can be secured to the attachment apparatus 1200 by an arm 1210, for example. In another approach, the holder is secured to the attachment apparatus directly, without the arm 1210 or other intermediate bracket.

These approach ensure that the tool is easily accessible and that the cord is kept close to the tool to minimize the required cord length and help prevent the cord from entangling with other instrument cords coupled to the dental delivery system.

In another implementation, the cord is used for a tool or other device not held in the holder 1211 and/or the holder is not provided.

The cord may include a connector 1221 configured to detachably connect to a connector of the tool's cord. This approach allows different tools to be easily connected to and disconnected from the cord. Also, a given tool can be easily detached from the connector and attachment apparatus at one location and moved to another location where the tool is easily attached to the connector and attachment apparatus of the another location. For example, a dentist can easily move a scanner from one operatory to another.

A cord boot 1222 surrounding the cord 1220 is received in a receptacle 1201r of the attachment apparatus 1200 to hold the cord in place. The cord is routed through a channel having a compression section which compresses or squeezes the cord to hold it in place. An opposing end of the cord can be routed from an end of the attachment apparatus 1200 into the interior of the console.

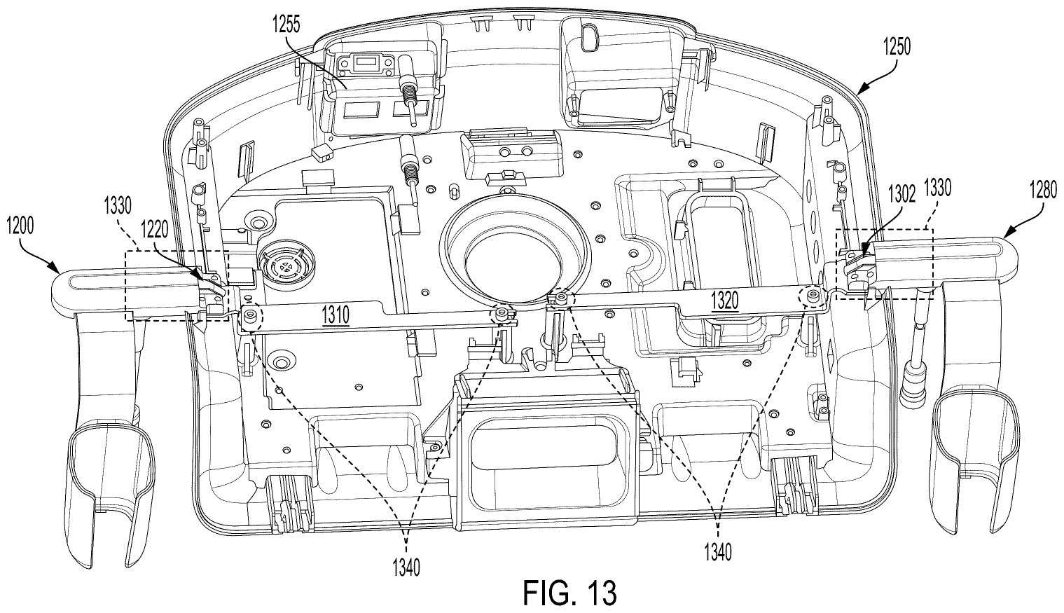

FIG. 13 depicts an example view of an interior of the tool console 1250 of FIG, 12, with the left side attachment apparatus 1200 of FIG. 12 and a right side attachment apparatus 1280, in accordance with various embodiments. The tool console can include a housing in which electronic components are provided, in an example implementation. One possible example is a console that holds dental tools and provides electric power to the tools.

The left side of the figure depicts the attachment apparatus 1200 routing a cord 1220 into the interior while the right side depicts the attachment apparatus 1280 routing a cord 1302 into the interior. The attachment apparatuses 1200 and 1280 are mounted to a frame of the interior using brackets 1310 and 1320, respectively. The brackets can be the same to allow the same bracket to work on the left side or right side, to provide flexibility for the end user and efficiency for the manufacturer. The attachment apparatuses can extend partway into openings such as through holes 1330 cut or otherwise provided on the left and right sides of the console. Mounting holes 1340 are also provided for attaching the brackets 1310 and 1320 to the console. The cord can be attached to a coupling box 1255 or other components in the console, or the console can act as a pass through for the cord to route it to another location. The coupling box can include a port for attachment to a power supply unit which in turn is coupled to alternating current (AC) mains power. The coupling box can include another port such as Universal Serial Bus (USB) port for coupling to a computer such as a laptop.

This example thus extends the capability of the console to include two additional tools of a non-standard size. In theory, additional tools could be accommodated as well with additional attachment apparatuses.

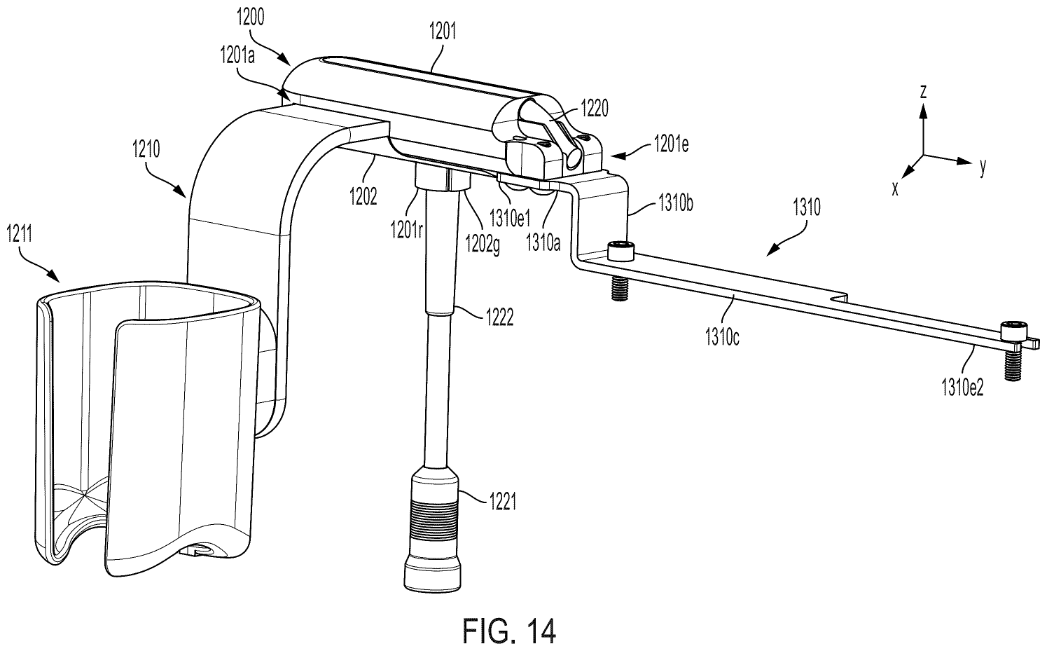

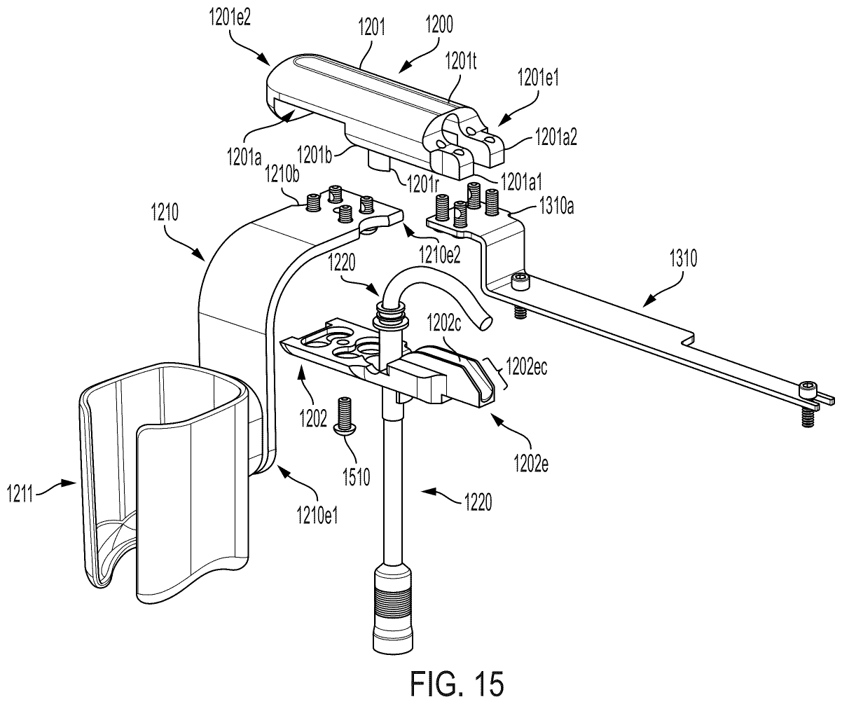

FIG. 14 depicts a view of an example implementation of the attachment apparatus 1200 of FIG. 12 and associated structures, in accordance with various embodiments. In an example implementation, the attachment apparatus includes a body 1201 and a bottom cap 1202 or cover. The body can include an opening 1201a (see also FIG. 15) through which the arm 1210 of the holder 1211 is inserted and held. In one approach, the opening extends through the body so that the arm can be inserted into either side of the body. This allows the attachment apparatus to be used on either the left or right side of the console. The holder 1211 can be easily swapped in the field with a holder of a different type, for instance, due to easy accessibility of screws (on the backside of the arm 1210) which attach the holder to the arm.

The body also includes a receptacle 1201r to receive the boot 1222 of the cord 1220. In an example implementation, the receptacle has a cylindrical interior extending over a major arc of a circle, e.g., more than 180 degrees of the circle. The receptacle has a gap on its side that is closed by a gate 1202g of the cap 1202 when the cap is attached to the body. The gate can extend over a minor arc of the circle, e.g., less than 180 degrees of the circle, and is mated with the receptacle when the cap is attached to the body.

Other approaches to securing the cord boot to the attachment apparatus are possible as well.

The cord 1220 passes up through the receptacle and is routed in an interior channel toward an end 1201e of the body. The bracket 1310 can be attached to the attachment apparatus using screws, for example. The bracket may be L-shaped and include a flat plate 1310a for attaching to bottom surfaces of the attachment apparatus, a vertical bend 1310b and an elongated flat plate 1310c for attaching to the console.

The bracket has a first end 1310e1 configured to be fastened to the spaced-apart arms and a second end 1310e2 configured to be attached to a dental tool console 1250.

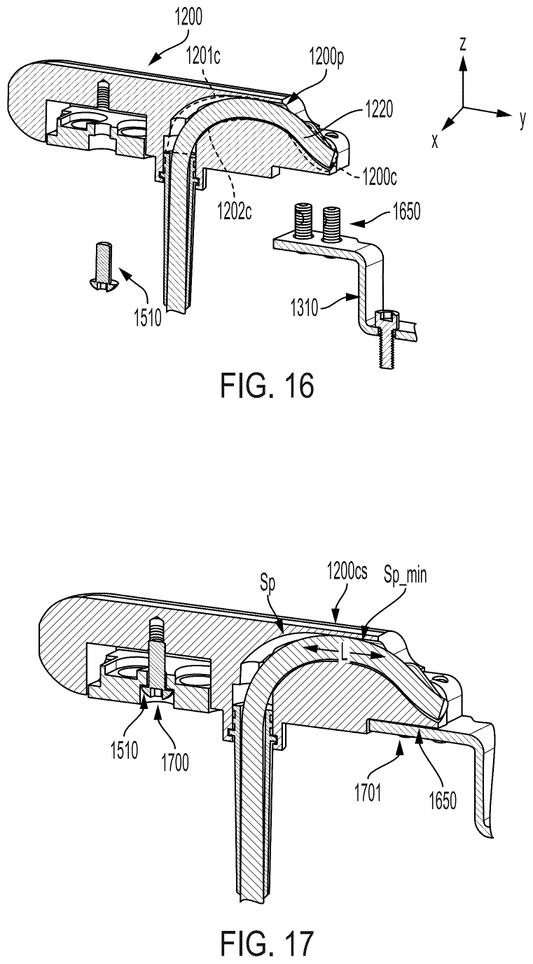

FIG. 15 depicts an exploded view of the attachment apparatus 1200 and associated structures of FIG. 14, in accordance with various embodiments. The arm 1210 includes a flat bracket 1210b attached to an underside of the body 1201 with screws after passing through the opening 1201a. The body 1201 includes first and second arms 1201a1 and 1201a2, respectively, which can be mounted to the flat plate 1310a using screws. The cover includes a channel surface 1202c extending in part over an extended portion 1202e of the cap. When the cord is in place and the cover is attached to the body, the channel surface 1202c compresses the cord against a corresponding channel 1201c (FIG. 16) in the body. An additional screw 1510 can be used to attach the cover to the body.

The arm 1210 has a first end 1210e1 coupled to the tool holder 1211 and a second end 1210e2 attachable to the bottom 1201b of the body proximate to the second end 1201e2 of the body, wherein the cap 1202 is to cover the second end of the arm.

The body 1201 can be elongated and has a top 1201t and bottom 1201b, and opposing first and second ends 1201e1 and 1201e2, respectively. Further, the body comprises the receptacle 1201r at the bottom having a cylindrical interior with a groove, and spaced-apart arms 1201a1 and 1201a2 at the first end. The receptacle is configured to hold the cord boot 1222, and the cylindrical interior extends over a major arc of a circle.

The cap comprises an exit channel 1202ec between the spaced-apart arms to guide the cord to an end 1201e of the body 1201. The cord can be exposed outside the body in the exit channel. The exit channel guides the cord to the first end 1201e1 of the body to provide the cord in an appropriate position to enter the dental tool console.

FIG. 16 depicts an exploded cross-sectional view of the attachment apparatus 1200 of FIG. 14 in the y-z plane, where a screw 1510 and the bracket 1310 are detached from the attachment apparatus 1200, in accordance with various embodiments. A channel 1200c is formed in the attachment apparatus between a first channel surface 1201c of the body and a second channel surface 1202c of the cover. The first and second channel surfaces extend from the receptacle to the end of the body. A distance or spacing Sp between the channel surfaces can vary over the length of the channel. In one approach, the distance is a minimum Sp_min at a compression section 1200ccs (FIG. 17) of the channel. The cord is trapped and slightly compressed in the compression section having a length L, e.g., at least 0.2-0.7 or at least 0.5-0.7 inches.

This provides a relatively long length for the compression section to provide a robust cord retention and strain relief, to resist the cord being pulled out inadvertently or from a worst case loading scenario. Moreover, it greatly reduces localized stress and the likelihood of wire breakage within the cord compared to a point loading, for example. The design can handle a side loading such as might occur if the user inadvertently walks away with the scanner or other tool while it is attached to the cord, and a vertical downward loading such as might occur if the user steps on the cord.

The first channel surface can be parallel to and/or equidistant from the second channel surface throughout a length of the compression section of the channel.

Defining specific channel geometry also forces cord minimum bend radii specifications to be observed.

Screws 1650 are also depicted for attaching the bracket to the body and holding the extended portion of the cover against the body.

FIG. 17 depicts a cross-sectional view of the attachment apparatus 1200 of FIG. 16, where the screw 1510 and the bracket 1310 are attached to the attachment apparatus 1200 to provide a compression section 1200cs of a channel 1200c, in accordance with various embodiments. The screws 1510 and 1650 are seated to secure the cover to the body and to provide a compressive force across the cord in the compression section. In one approach, the screws are not placed directly under the compression section. Instead, placing the screws fore and aft of the compression section creates a bending effect across the cap.

Thus, in an example implementation, the cap is fastened to the body at a first location 1700 spaced apart from the compression section of the channel on one side of the compression section and at a second location 1701 spaced apart from the compression section on another, opposite side of the compression section, but not fastened to the body at a location between the first and second locations or otherwise directly under, over or to the side of the compression section.

Alternatively, fasteners could be provided to attach the cap to the body in one location, directly under the compression section.

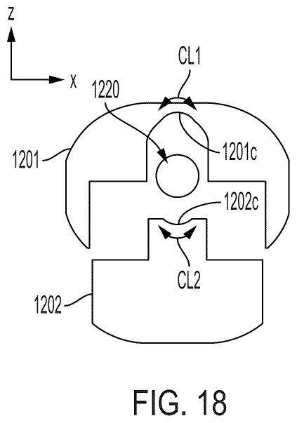

FIG. 18 depicts a cross-sectional view of the attachment apparatus 1200 in an x-z plane, showing a contact radius of a first channel surface 1201c and a second channel surface 1202c along the length L of the compression section 1200cs of FIG. 17, in accordance with various embodiments. The contact radius refers to a circumferential distance at which the channel surfaces 1201c and 1202c of the body and the cap, respectively, contact the cord 1220 in the compression section. The channel surfaces 1201c and 1202c form a passageway 1200p for a cord between the body and the cap. In one approach, the circumferential lengths CL1 and CL2 of the first and second channel surfaces, respectively, combined (e.g., CL1+CL2) are configured to contact the cord at more than one-third and no more than one-half of a circumference of the cord. In another approach, the circumferential lengths CL1 and CL2 of the first and second channel surfaces, respectively, combined are configured to contact the cord at more than one-half and no more than 80% of a circumference of the cord. The cable contact radius can be about ⅓-⅔ of the cable circumference.

These approaches can provide an optimal amount of compression of the cord to balance holding the cord in place while avoiding damage to the cord. For example, they allow some cord flex and movement during compression. In contrast, a 100% contact radius between the body/cap and the cord could result in an over-constrained system which does not provide a buffer to accommodate manufacturing variations such as in the circumference of the cord.

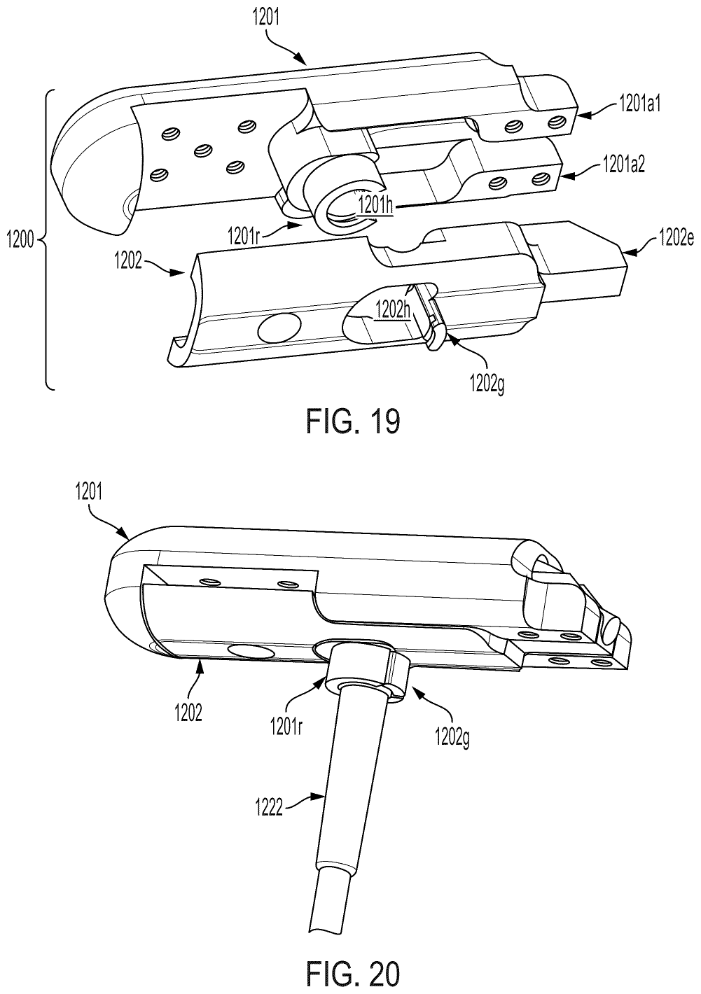

FIG. 19 depicts a view of the attachment apparatus 1200 with the cap 1202 detached from the body 1201, in accordance with various embodiments. The receptacle 1201r of the body 1201 includes an aperture 1201h or hole through which the cord passes when it is installed in the attachment apparatus. The presence of the gap in the receptacle helps facilitate the installation of the cord. The cap 1202 similarly includes an aperture 1202h through which the receptacle passes.

In an example implementation, the diameters of the apertures 1201h and 1202h are about 0.4 and 0.7 inches, respectively. This is suitable for some types of cords that are expected to be used. The design provides a cost effective cord retention device that provides passage of a relatively large diameter end connector while rigidly fixing the smaller diameter midsection of the cord.

The gate 1202g of the cover is also depicted along with the extended portion 1202e of the cover and the arms 1201a1 and 1201a2 of the body 1201.

FIG. 20 depicts a view of the attachment apparatus 1200 with the cap 1202 attached to the body 1201, in accordance with various embodiments. This view indicates how the gate 1202g mates with the receptacle to trap the cord boot 1222 in the receptacle 1201r.

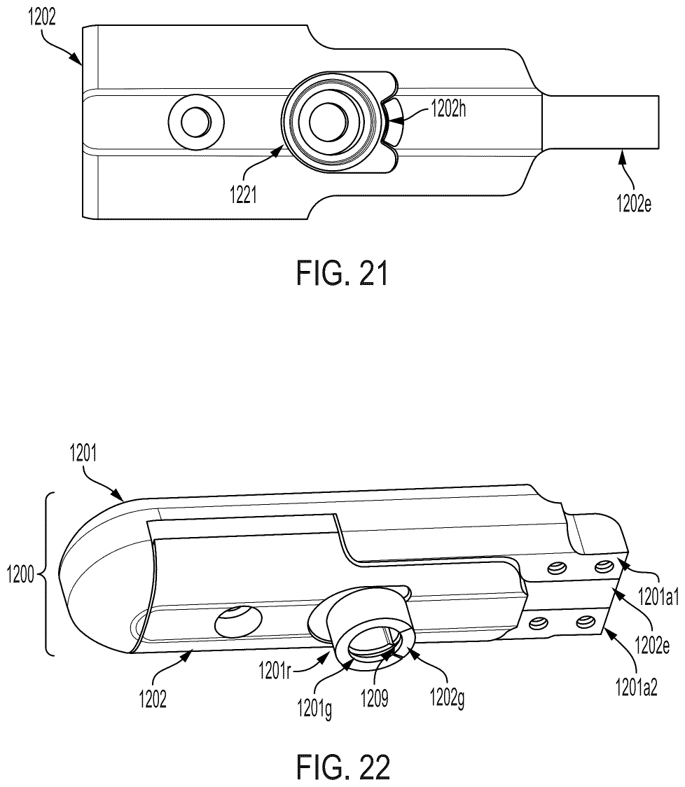

FIG. 21 depicts a view of the cap 1202 of the attachment apparatus 1200, showing the aperture 1202h sized to pass through a cord connector 1221, in accordance with various embodiments. This may be the first step of installing the cord. In an example implementation, the aperture is about a 0.7 inch hole for the cord connector.

FIG. 22 depicts a view of the cap 1202 attached to the body 1201 of the attachment apparatus 1200, showing a gate 1202g of the cap mating to the receptacle 1201r of the body 1201, a groove 1201g of the receptacle 1201r, and a groove 1209 of the gate, without a cord present, in accordance with various embodiments. The groove, or in-cut ring, can be provided in the interiors of both the receptacle 1201r and the gate 1202g so that a corresponding flange of the cord boot is held in the grooves, and the cord boot is thereby held securely in place. The groove of the receptacle is thus used to mate with the flange in the tip of the cable boot. After final assembly of the cap to the body, the cable boot and cable are securely nested in the receptacle. In an example implementation, the cover and body are made of metal and the cord boot is made of rubber or plastic.

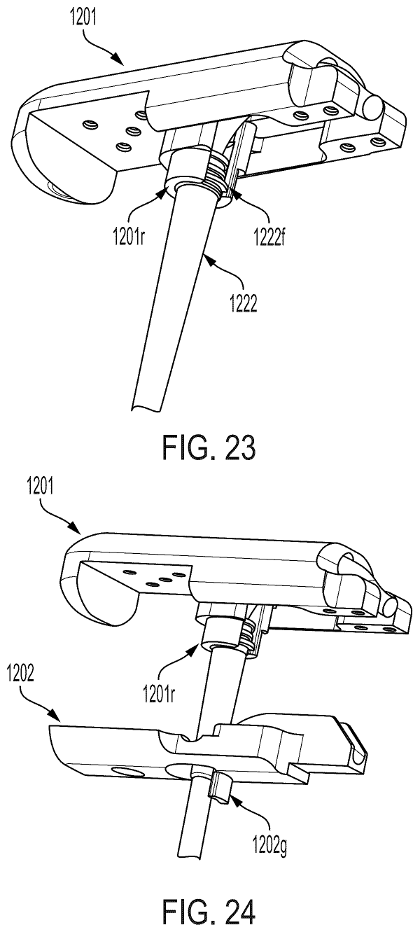

FIG. 23 depicts an underside of the body 1201 of the attachment apparatus 1200, showing the cord boot 1222 mated via a flange 1222f to the groove of the receptacle 1201r, in accordance with various embodiments. This may be the second step of installing the cord. Here, a flange 1222f of the cord boot is visible. The cord boot flange or ring is seated into the receptacle of the body for stress relief.

Note that one or more grooves may be provided in the interior of the receptacle and in the gate, and the cord boot may similarly have one or more flanges to seat in the one or more grooves, respectively, with one groove per flange. It is also possible for the interior of the receptacle and the gate to have multiple spaced-apart grooves to accommodate one flange of the cord boot in different positions. Other mating mechanism other than grooves could be used as well, such as spikes or other protrusions that mate with indentations.

FIG. 24 depicts the cap 1202 being mated to the body 1201 of FIG. 23, in accordance with various embodiments. This may be the third step of installing the cord. This step involves moving the cap toward the body, thereby seating the cap onto the body, while ensuring that the gate of the cap is seated with the cord boot and the receptacle. Finally, the screws 1510 and 1650 are tightened.

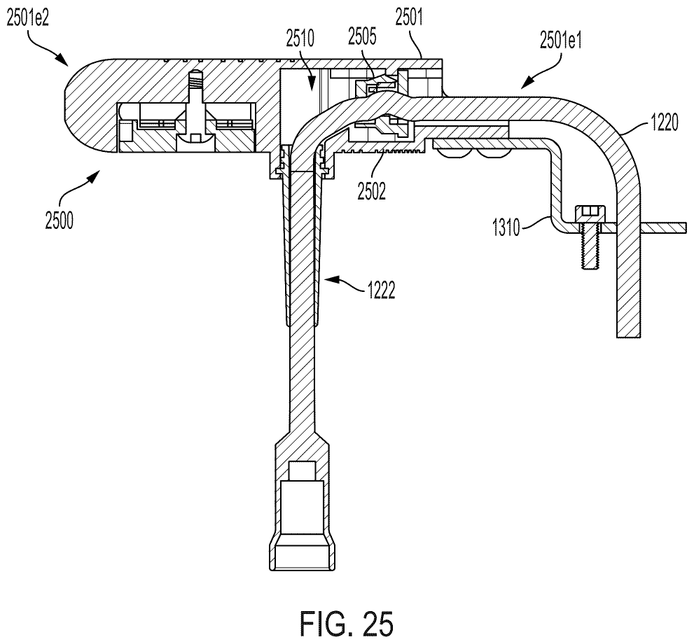

FIG. 25 depicts a view of an attachment apparatus 2500 which provides another example implementation of the attachment apparatus 1200 of FIG. 12, in accordance with various embodiments. The attachment apparatus 2500 includes a body 2501 and a cap 2502 which is attachable to a bottom of the body to secure the cable 1220 and its boot 1222. The body is elongated and has opposing first and second ends 2501e1 and 2501e2, respectively. In this implementation, the boot is held by a receptacle of the body, as discussed previously. However, instead of compressing the cord between channels of the body and cap, a bushing 2505 is held within the attachment apparatus 2500 between the body and the cap. The bushing can be a strain-relief bushing, for example.

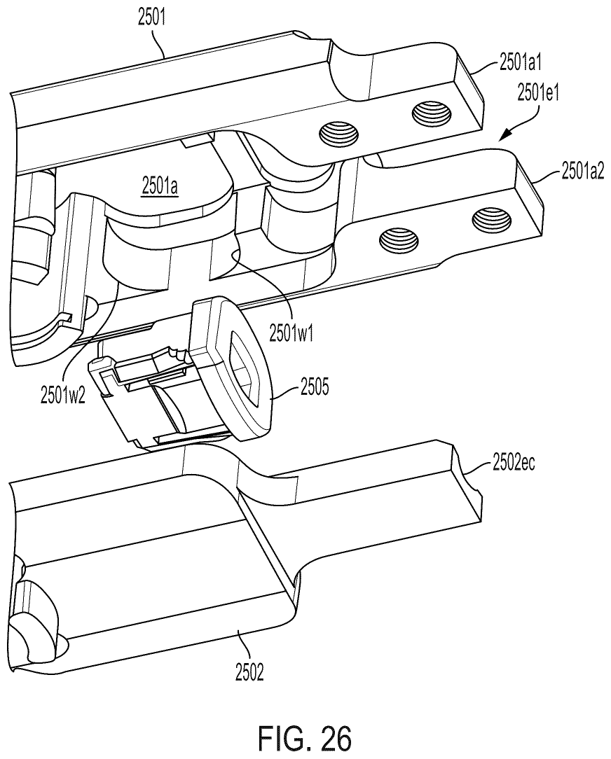

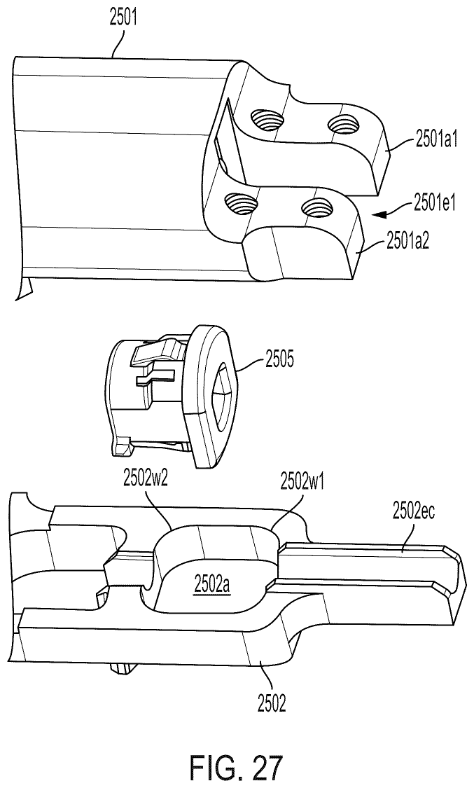

In one approach, the bushing includes an opening portion or door that includes a hinge on one side and a locking tab on the other side. When the door is opened, a cord can be inserted into the bushing. In particular, during assembly of the attachment apparatus, before the cap is attached to the body, the door of the bushing is opened to allow the cord to be placed into the center of the bushing. The door is then closed and locked around the cord to hold the cord in place. The bushing is placed in cutout regions 2501a and 2502a (FIGS. 26 and 27) of the body and cap, respectively, in one approach, where the bushing is held in place. The cap is attached to the body to complete the assembly of the attachment apparatus. When the bushing is closed, a force is applied to the cord which holds it in place. In particular, the bushing may include surfaces which create crimps or slight bends in the cord as shown to prevent movement of the cord. The cord is thus held firmly in a passageway 2510 between the body and cap.

FIG. 26 depicts an upward view of the body 2501, cap 2502 and bushing 2505 of FIG. 25, in accordance with various embodiments. A top part of the bushing 2505 is held within the cutout region 2501a (or chamber or void) in the body 2501. The cutout region includes opposing side walls 2501w1 and 2501w2 that prevent the bushing from moving along the length of the attachment apparatus.

The cap 2502 includes an exit channel 2502ec which fits between the arms 2501a1 and 2501a2 of the body when the cap is attached to the body. The exit channel extends from an end of the cap in a direction of the length of the cap. The exit channel 2502ec guides the cord to the first end 2501e1 of the body to provide the cord in an appropriate position to enter the dental tool console.

FIG. 27 depicts a downward view of the body 2501, cap 2502 and bushing 2505 of FIG. 25, in accordance with various embodiments. A bottom part of the bushing 2505 is held within the cutout region 2502a in the cap 2502. The cutout region includes opposing side walls 2502w1 and 2502w2 that prevent the bushing from moving along the length of the attachment apparatus.

Some non-limiting examples of various embodiments are presented below.

Example 1 includes an apparatus, comprising: a holder configured to hold a tool; an adapter body having a back side coupled to the holder, and an opposite front side, the front side having first and second curved edges configured to contact a front side of an elongated arm; the adapter body having a cavity at the second side between the first and second curved edges; a tension screw seated in the adapter body outside the cavity; a fastener threaded onto the tension screw; and a clamp configured to contact a back side of the elongated arm, the clamp having a first tab at a first end configured to be fastened to the adapter body and a second tab at an opposite second end configured to be fastened to the fastener.

Example 2 includes the apparatus of Example 1, wherein the tension screw has a tip held in a first seat of the adapter body, a head held in a second seat of the adapter body, and a threaded shaft onto which the fastener is threaded.

Example 3 includes the apparatus of Example 2, wherein the first and second seats substantially prevent longitudinal movement of the tension screw relative to the adapter body.

Example 4 includes the apparatus of Example 2 or 3, wherein the tip of the tension screw is retained between the first seat and a retaining screw fastened to the adapter body.

Example 5 includes the apparatus of any one of Examples 2-4, wherein the head of the tension screw is accessible from an exterior of the adapter body.

Example 6 includes the apparatus of any one of Examples 2-5, wherein the fastener and the second tab of the clamp move away from the head of tension screw when clamp is tightened by rotating the tension screw.

Example 7 includes the apparatus of Example 6, wherein the tension screw is left-hand threaded.

Example 8 includes the apparatus of any one of Examples 1-7, wherein a longitudinal axis of the tension screw extends generally horizontally.

Example 9 includes the apparatus of any one of Examples 1-8, wherein the cavity is configured to accommodate one or more protrusions of the elongated arm between the first and second curved edges.

Example 10 includes the apparatus of any one of Examples 1-9, wherein the elongated arm comprises a plurality of slots for holding a dental handpiece as part of a dental delivery system and the apparatus covers one of the slots without covering any other slot of the plurality of slots.

Example 11 includes an apparatus, comprising: a body comprising a receptacle having a cylindrical interior with a groove, wherein the body has a first channel surface extending from the receptacle to an end of the body, the receptacle is configured to hold in place a cord boot, and the cylindrical interior extends over a major arc of a circle; and a cap configured to be attached to the body, wherein the cap includes a second channel surface, a channel for a cord is formed between the first and second channel surfaces when the cap is attached to the body, a distance between the first and second channel surface varies over a length of the channel and is a minimum in a compression section of the channel in which a cord is compressed, and the cap comprises a gate which extends over a minor arc of the circle and mated with the receptacle when the cap is attached to the body.

Example 12 includes the apparatus of Example 11, wherein the cap comprises an aperture through which the receptacle passes when the cap is attached to the body, and the gate is adjacent to the aperture.

Example 13 includes the apparatus of Example 11 or 12, wherein the gate comprises a groove corresponding to the groove of the cylindrical interior of the receptacle.

Example 14 includes the apparatus of any one of Examples 11-13, wherein to hold in place the cord boot in the receptacle, the groove of the receptacle is to mate with a flange of the cord boot.

Example 15 includes the apparatus of any one of Examples 11-14, wherein a length of the compression section of the channel is at least 0.2-0.7 inches.

Example 16 includes the apparatus of any one of Examples 11-15, wherein circumferential lengths of the first and second channel surfaces combined are configured to contact the cord at more than one-third and no more than one-half of a circumference of the cord.

Example 17 includes the apparatus of any one of Examples 11-16, wherein circumferential lengths of the first and second channel surfaces combined are configured to contact the cord at more than one-half and no more than 80% of a circumference of the cord.

Example 18 includes the apparatus of any one of Examples 11-17, wherein the first channel surface is equidistant from the second channel surface throughout a length of the compression section of the channel.

Example 19 includes the apparatus of any one of Examples 11-18, wherein the cap is fastened to the body at a first location spaced apart from the compression section of the channel on one side of the compression section and at a second location spaced apart from the compression section on another, opposite side of the compression section, but not fastened to the body at a location between the first and second locations.

Example 20 includes the apparatus of any one of Examples 11-19, wherein the body comprises means for attaching a tool holder.

Example 21 includes the apparatus of any one of Examples 11-20, wherein the body includes spaced-apart arms at the first end of the body, the second channel surface of the cap extends over an extended portion of the cap, and the extended portion of the cap extends between the spaced-apart arms when the cap is attached to the body.

Example 22 includes the apparatus of Example 21, further comprising a bracket configured to be fastened to the spaced-apart arms, wherein the extended portion is held against the body when the bracket is fastened to the spaced-apart arms.

Example 23 includes an apparatus, comprising: a body comprising a top and bottom, and opposing first and second ends, wherein the body comprises a receptacle at the bottom having a cylindrical interior with a groove, and spaced-apart arms at the first end, the receptacle is configured to hold a cord boot, and the cylindrical interior extends over a major arc of a circle; and a cap configured to be attached to the bottom of the body, wherein the cap comprises a gate which extends over a minor arc of the circle and is mated with the receptacle when the cap is attached to the body, a passageway between the body and cap is configured to hold the cord, and the cap further comprises an exit channel extending between the spaced-apart arms to guide the cord to an end of the body.

Example 24 includes the apparatus of Example 23, wherein the cap comprises an aperture through which the receptacle passes when the cap is attached to the body, and the gate is adjacent to the aperture.

Example 25 includes the apparatus of Example 23 or 24, wherein the gate comprises a groove corresponding to the groove of the cylindrical interior of the receptacle.

Example 26 includes the apparatus of any one of Examples 23-25, wherein the groove of the receptacle is configured to mate with a flange of the cord boot to hold the cord boot in the receptacle.

Example 27 includes the apparatus of any one of Examples 23-26, further comprising an arm having a first end coupled to a tool holder and a second end attachable to the bottom of the body proximate to the second end of the body, wherein the cap is to cover the second end of the arm.

Example 28 includes the apparatus of any one of Examples 23-27, further comprising a bracket having a first end configured to be fastened to the spaced-apart arms and a second end configured to be attached to a dental tool console.

Example 29 includes the apparatus of any one of Examples 23-28, wherein the passageway comprises a strain-relief bushing configured to hold the cord.

Example 30 includes the apparatus of Example 29, wherein the strain-relief bushing is held in opposing interior cutout regions of the body and cap.

Example 31 includes the apparatus of any one of Examples 23-28, wherein: the passageway comprises a first channel surface of the body and a second channel surface of the cap; and a distance between the first and second channel surfaces varies over a length of the passageway and is a minimum in a compression section of the passageway in which the cord is configured to be compressed.

Example 32 includes the apparatus of Example 31, wherein the first and second channel surfaces combined are configured to contact the cord at more than one-third and no more than 80% of a circumference of the cord.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways. This application is intended to cover any adaptations or variations of the embodiments discussed herein. Therefore, it is manifestly intended that embodiments be limited only by the claims and the equivalents thereof.

What is claimed is:

1. An apparatus, comprising:
a holder configured to hold a tool;
an adapter body having a back side coupled to the holder, and an opposite front side, the front side having first and second curved edges configured to contact a front side of an elongated arm;
the adapter body having a cavity at the second side between the first and second curved edges;
a tension screw seated in the adapter body outside the cavity;
a fastener threaded onto the tension screw; and
a clamp configured to contact a back side of the elongated arm, the clamp having a first tab at a first end configured to be fastened to the adapter body and a second tab at an opposite second end configured to be fastened to the fastener.

2. The apparatus of claim 1, wherein the tension screw has a tip held in a first seat of the adapter body, a head held in a second seat of the adapter body, and a threaded shaft onto which the fastener is threaded.

3. The apparatus of claim 2, wherein the first and second seats substantially prevent longitudinal movement of the tension screw relative to the adapter body.

4. The apparatus of claim 2, wherein the tip of the tension screw is retained between the first seat and a retaining screw fastened to the adapter body.

5. The apparatus of claim 2, wherein the head of the tension screw is accessible from an exterior of the adapter body.

6. The apparatus of claim 2, wherein the fastener and the second tab of the clamp move away from the head of tension screw when clamp is tightened by rotating the tension screw.

7. The apparatus of claim 6, wherein the tension screw is left-hand threaded.

8. The apparatus of claim 1, wherein a longitudinal axis of the tension screw extends generally horizontally.

9. The apparatus of claim 1, wherein the cavity is configured to accommodate one or more protrusions of the elongated arm between the first and second curved edges.

10. The apparatus of claim 1, wherein the elongated arm comprises a plurality of slots for holding a dental handpiece as part of a dental delivery system and the apparatus covers one of the slots without covering any other slot of the plurality of slots.

11. An apparatus, comprising:
a body comprising a top and bottom, and opposing first and second ends, wherein the body comprises a receptacle at the bottom having a cylindrical interior with a groove, and spaced-apart arms at the first end, the receptacle is configured to hold a cord boot, and the cylindrical interior extends over a major arc of a circle; and
a cap configured to be attached to the bottom of the body, wherein the cap comprises a gate which extends over a minor arc of the circle and is mated with the receptacle when the cap is attached to the body, a passageway between the body and cap is configured to hold the cord, and the cap further comprises an exit channel extending between the spaced-apart arms to guide the cord to the first end of the body.

12. The apparatus of claim 11, wherein the cap comprises an aperture through which the receptacle passes when the cap is attached to the body, and the gate is adjacent to the aperture.

13. The apparatus of claim 11, wherein the gate comprises a groove corresponding to the groove of the cylindrical interior of the receptacle.

14. The apparatus of claim 11, wherein the groove of the receptacle is configured to mate with a flange of the cord boot to hold the cord boot in the receptacle.

15. The apparatus of claim 11, further comprising an arm having a first end coupled to a tool holder and a second end attachable to the bottom of the body proximate to the second end of the body, wherein the cap is to cover the second end of the arm.

16. The apparatus of claim 11, further comprising a bracket having a first end configured to be fastened to the spaced-apart arms and a second end configured to be attached to a dental tool console.

17. The apparatus of claim 11, wherein the passageway comprises a strain-relief bushing configured to hold the cord.

18. The apparatus of claim 17, wherein the strain relief bushing is held in opposing interior cutout regions of the body and cap.

19. The apparatus of claim 11, wherein:
the passageway comprises a first channel surface of the body and a second channel surface of the cap; and
a distance between the first and second channel surfaces varies over a length of the passageway and is a minimum in a compression section of the passageway in which the cord is configured to be compressed.

20. The apparatus of claim 19, wherein the first and second channel surfaces combined are configured to contact the cord at more than one-third and no more than 80% of a circumference of the cord.
